(19) United States
(12) Patent Application Publication
(10) Pub. No.: US 2007/0175358 A1
(43) Pub. Date: Aug. 2, 2007

(54) ELECTROLESS GOLD PLATING SOLUTION

(76) Inventor: Kilnam Hwang, Cranston, RI (US)

Correspondence Address: WINSTON & STRAWN LLP;PATENT DEPARTMENT, 1700 K STREET, N.W., WASHINGTON, DC, 20006, US

(21) Appl. No.: 11/566,971

(22) Filed: Dec. 5, 2006

Related U.S. Application Data
(60) Provisional application No. 60/764,574, filed on Feb. 1, 2006.

(51) Int. Cl. B05D 1/18; B05D 5/00; C23C 18/48

(52) U.S. Cl. 106/1.22; 427/443.1; 427/437; 427/282

(57) ABSTRACT

An electroless gold plating solution that includes a solution- or water-soluble gold compound that provides gold ions, a complexing agent for the gold ions comprising a mixture of a sulfite and a thiosulfate in a weight ratio of greater than 1:2 to 50: 1, a reducing agent, and a benzoic acid compound having one to four hydroxyl group(s) or a solution- or water-soluble salt thereof in an amount sufficient to act as a stabilizer for the solution. Also disclosed are methods for electrolessly plating gold on a substrate or article.

This application claims the benefit of application No. 60/764,574 filed Jan. 31, 2006, the entire content of which is expressly incorporated herein by reference thereto.

### BACKGROUND

The present invention relates to an electroless gold plating solution including a solution-soluble gold compound, the mixture of a sulfite and a thiosulfate as complexing agents, a reducing agent, and benzoic acid components having hydroxyl groups as a stabilizer.

A number of electroless gold plating solutions have previously been suggested which provide relatively non-hazardous bath chemistry with a neutral pH operating range and a lower operating temperature. In order to meet requirements of high technology manufacturing processes in the electronics industries, an electroless gold solution should be compatible with resists and have a relatively low operating temperature for heat-sensitive electronics.

Gold (I) sulfite or gold (I) thiosulfate complexes for electroless gold plating have been used previously for replacing the conventional cyanide-based solutions. These solutions have excellent stability but operate at a high pH and temperature. Sulfite or thiosulfate based electroless gold plating solutions require stabilizing additives, such as a polyamine, 2,2′-bipyridine, mercaptobenzothiazole, and benzotriazole, to minimize solution instability caused by the low complex formation constants of the gold sulfite and gold thiosulfate, which are approximately 10¹⁰ and 10²⁶ respectively. Using either of these components makes unstable plating solutions, because they form a weak gold complex compared to the gold cyanide complex with a 10³⁹ complex formation constant.

The combination of sulfite and thiosulfite gold complexes, however, can provide relatively stable electroless gold plating solutions, and these complexes have been used in most non-cyanide gold plating formulation disclosed recently.

U.S. Pat. No. 5,232,492 discloses that the use of mixtures of sulfite and thiosulfate complexes provide a stable electroless plating solution when ethylenediaminetetraacetic acid disodium salt is used as an oxidation rate controller. The thiosulfate increases the stability of the initial gold sulfite complex by also forming gold thiosulfate complexes and functions as a source of sulfites. The gold thickness plated over an immersion gold deposit under conditions of pH 7.5 and 65° C. is 7 microinches after 15 minute.

U.S. Pat. No. 5,470,381 disclosed an electroless gold deposition solution containing tetrachlorogold(III) complexes or gold(I) complexes with thiosulfate or sulfite as the complexing agent, plus ascorbic acid, a pH buffer and organic sulfur compounds to stabilize the solution to prevent spontaneous decomposition. The deposition rate is 0.6 to 1 μm/hour at a pH of 6 to 8.

JP Pat. No. 7-118867 describes the use of a phenyl compound and thiourea as a reducing agent in the plating solution comprising gold complexes of a sulfite and thiosulfate. The patent claims that the phenyl compound based reducing agent provides an improvement in stability by reducing by-products of thiourea.

JP Pat. No. 2004-169058 discloses an electroless gold plating solution comprising a phenyl compound, benzotriazole, and a mercaptan compound as a stabilizer in the range of 1 to 50 ppm. The use of sulfite and thiosulfate as gold complexes are not mentioned in the application, but the bath may need these gold complexes to get a proper gold deposit. The gold plating rate obtained is about 0.7 to 0.85 μm/hour under the conditions of pH 7.4 and 65° C.

U.S. Pat. No. 5,364,460 discloses an electroless gold bath comprising a gold sulfite complex, reducing agent, such as hydrazine, ascorbic acid, trimethylaminoborane and dimethylaminoborane, and an organic phosphonic acid. The solution also contains amino acids or aminobenzoic acid to increase the plating rate. The pH of the solution is in the range of 7 to 9. The plating rate is given as about 0.6 μm/hour. It is stated that the plating rate is too low when the pH is below 6.

JP Pat. No. 2004-323895 discloses an electroless plating solution consisting of a water-soluble poly amino polycarboxylic acid, oxy acid such as glycolic acid, diglycolic acid, a pyrogallol as a reducing agent and a benzotriazole as a metal elution inhibitor. This bath uses the mixture of a sulfite and thiosulfate to obtain the described plating rate which is 1.36 μm/hour at pH 7.0 and 70° C.

Despite these solutions, there remains a need for improved electroless gold deposit processes, and these are now provided by the present invention.

### SUMMARY OF THE INVENTION

The present invention relates to an electroless gold plating solution comprising a solution-soluble gold compound that provides gold ions, a complexing agent for the gold ions comprising a mixture of a sulfite compound and a thiosulfate compound in a weight ratio of greater than 1:2 to 50:1, a reducing agent, and a benzoic acid compound having one to four hydroxyl group(s) or a solution-soluble salt thereof in an amount sufficient to act as a stabilizer for the solution.

The invention also relates to a method for electroless gold plating which comprises contacting a substrate to be plated with one of the electroless plating solutions defined herein for a time sufficient to provide an electroless gold deposit upon the portions of the substrate that are contacted by the solution. Preferably, the substrate is immersed in the solution and its entire outer surface is provided with an electroless gold deposit. If desired, a substrate protecting organic material can be provided upon the substrate so that the gold plating is provided only upon selected portions of the substrate. Preferred substrate protecting organic materials include a benzotriazole, mercaptobezimidazole, or imidazole compound.

### BRIEF DESCRIPTION OF THE DRAWING FIGURES

FIG. 1 is a graph illustrating gold deposit thickness based on plating rate and plating time for the solution of Example 13; and

FIG. 2 is an illustration of electroless gold plating on pre-defined gold lines (250 μm line width) on the polymer substrate for 10 minutes using the solution of Example 13.

### DETAILED DESCRIPTION OF THE PREFERRED EMBODIMENTS

The electroless gold plating solutions of the invention can provide excellent uniformity and smoothness of the gold deposit with a high plating rate and good stability. As noted above, the electroless gold plating solution comprises a solution-soluble gold compound, the mixture of a sulfite and a thiosulfate as gold complexing agents, a reducing agent and a benzoic acid compound as a stabilizer.

Any solution- or water-soluble gold compound can be used in this invention. The amount can be determined based on routine testing of the particular compound in the particular solution being prepared. The water-soluble gold compound may be a sulfite gold salt or a thiosulfate gold salt and is typically present in an amount of about 1 to 20 g/l. A more preferred amount of water-soluble gold compound is typically in the range of 1 to 8 g/l.

The complexing agent is a mixture of a sulfite compound and a thosulfate compound so that the solution is provided with sulfite and thiosulfate ions, with each preferably being present in the range of 4 to 85 g/l and 1 to 35 g/l respectively. Preferably, the sulfite and thiosulfate compound are present at a weight ratio of greater than 1:1 to 25:1 and is typically present in an amount of about 5 to 125 g/l. The mixture of sulfite and thiosulfate compounds preferably includes those having alkali metal, ammonium or alkyl cations.

The reducing agent may be one or more of hypophosporous acid, hydroxylamine, hydrazine, hydroquinone, catechol, pyrogallol, gallic acid, thiourea, urea, ammonium hydroxyl sulfonic acid, or one of their solution-soluble salts, and is typically present in an amount of about 1 to 60 g/l.

The benzoic acid compound is typically present in an amount of about 5 to 50 g/l. It may be a dihydroxy or trihydroxy benzoic acid that has two or three hydroxyl groups, and preferably is 2,4-dihydroxybenzoic acid, 2,5-dihydroxybenzoic acid, 3,4-dihydroxybenzoic acid, 3,5-dihydroxybenzoic acid, 2,3-dihydroxybenzoic acid, or 2,6-dihydroxybenzoic acid, or is a dihydroxy benzoate of an alkali metal or a halide. The benzoic acid components are present in an amount of 1 to 30 g/l and serve as a stabilizer through the formation of a gold complex.

The electroless gold solution can further contain a tartaric acid or solution-soluble salt thereof as a grain refiner typically present in an amount of about 1 to 40 g/l. Aliphatic compounds having carboxylic and hydroxyl groups may also be useful in the present invention as grain refiners at the same concentration.

If necessary, a pH regulating compound can be used, preferably one that does not have alkali metal ions, with the pH maintained in the range of about 5 to 9. Preferred pH regulating compounds include ammonium borate, triethanolamine, or ammonium phosphate and the pH is preferably maintained in the range of about 5.5 to 7.5. Any pH regulating compound which does not adversely affect the bath's gold plating capabilities may be used in these compositions. The preferred pH-regulating compound is a borax derivative and the preferred amount is 1 to 20 g/l.

The balance of the solution is water. By formulating it as described herein, the resulting solution then can be free of alkali metal ions. Finally, if desired, the solution can further comprise conventional amounts of one or more of a polyamine and polyaminepolycarboxylic acid or one of their solution-soluble salts as a surfactant.

A number of electroless gold plating solutions including a variety of reducing agents and stabilizers have been disclosed in recent years, but they all exhibit problems of unstable solutions and slow plating speeds which limit their use in production. Most reducing compounds used in electroless gold plating formulations need a stabilizer to prevent a disproportion reaction of gold ions, 3Au (I)→2Au+Au (III). The instability of solutions containing reducing components may mainly be caused by uncontrollable reducing activity or by dissolved impurities which enhance a disproportion reaction of gold ions into the solution during the plating operation.

Various organic components forming complexes with gold ions have been used as stabilizers such as solution- or water-soluble amine compounds and polyaminecarboxyl compound in order to obtain a stable electroless gold plating solution. A mercaptobenzothiazole compound and benzotriazole based compound have also been used as stabilizers. These stabilizers work by suppressing the mixing of metal impurities into the plating solution during the plating operation. The electroless gold plating solutions having these stabilizers have undergone a decomposition of solutions during storage or during a plating operation because the disclosed stabilizers failed in inhibiting the uncontrollable reduction of gold by strong reducing compounds in the solutions.

In order to keep a stable solution and obtain a practical plating rate, the desirable function of a stabilizer in combination with a reducing component in an electroless gold plating solution should be to control the driving force of the reducing agent and to prevent a disproportion reaction of gold ion itself. In the present invention a stabilizer, benzoic acid having hydroxyl groups, may provide a stable electroless gold solution by forming complexes with gold ions and by controlling the driving force of a reducing agent.

The present electroless gold plating compositions comprising benzoic acid having hydroxyl groups as a stabilizer in combination with reducing agents can produce a gold deposit at relatively low temperatures and a neutral pH range.

### EXAMPLES

The present invention will be described in detail in the following examples. These examples are intended to be illustrative of the invention and not to limit the invention. The electroless gold plating solution of the present invention can be applied for building up a gold deposit on a thin immersion gold layer over a nickel underlayer which may be plated by electroless or electrolytic plating method. All test pieces were copper clad printed circuit boards coated with a thin immersion gold and a medium phosphorous electroless nickel deposit. Gold plating efficiency will decrease with an increasing phosphorous content in an electroless nickel deposit. A thick gold deposit with a practical plating speed is obtained by an autocatytic reaction in the present electroless gold solution containing a source of gold, the mixed complexing components of a sulfite and thiosulfate, one or more reducing agents selected from a hydrazine, a thiourea, a hydroxylamine, a hypophosphoric acid or its salt, a hydroquinone, and a pyrogallol component, and benzoic acid components having hydroxyl groups as stabilizers for regulating the aggressive reducing reaction of the reducing agent.

The benzoic acids having two hydroxyl groups include hydroxybenzoic acid and dihydroxy benzoic acid are preferred, and these are 2,4-dihydroxybenzoic acid, 3,5-dihydroxybenzoic acid, 2,6-dihydroxybenzoic acid, and 2,3-dihydroxybenzoic acid. If desired, tri or tetrahydroxy benzoic acids can be used. The concentration of a benzoic acid component having hydroxyl groups as a stabilizer is in the range of 5 to 50 g/l. It is preferred that the stabilizer content in the plating solution be in the range of 15 to 35 g/l. When the stabilizer content is less than 5 g/l, the electroless plating solution decomposes during the plating operation. On the other hand, when the stabilizer content exceeds 50 g/l, the gold plating speed is dramatically reduced by hindrance of the reduction reaction of gold ions. These stabilizers can also be used on the form of a solution-soluble salt. Such salts include those based on alkali metals, alkali earth metals, or halide ions. Hydroxy benzoates are also suitable in this invention.

Test articles in the following examples have a size of 5.0 cm by 5.0 cm coated by an immersion gold layer on an underlying nickel deposit over a copper clad laminate printed circuit board material. The immersion gold layer is 7 microinches which provides good adhesion between the gold deposit and a nickel underlayer having a thickness of 5 micrometers.

The test article was prepared with the following sequence, rising 3 times with DI water after finishing each process step. It was treated with an acid cleaner, TechniClean AT-1000 (manufactured by Technic Inc.) at 50° C. for 3 minutes to remove oxides, fingerprints, and stains from the copper surface. Then the article was immersed in a microetch solution, TechniEtch AT-2000, at room temperature for 1 min. Further, the article was subject to an acid activation process, TechniActivator AT 3000, at room temperature for 30 seconds to provide adherent deposits to copper. Then the article was immersed in a palladium catalyst solution, TechniCatalyst AT-4000, at room temperature for one minute to support the uniform initiation of nickel reduction on the copper surface. Subsequently, the article was plated with an electroless nickel process, TechniENickel AT-5000, at 90° C. for 15 minutes to make an electroless deposit having 7-10% P content. Finally, the article was immersed in an immersion gold solution, Techni Oromerse SO, at 80° C. for 8 minutes.

### Example 1

An electroless gold plating solution was prepared and carried out by combining the following:

| Gold as Ammonium Gold Sulfite | 3.4 | g/l |
|---|---|---|
| Ammonium Sulfite | 42 | g/l |
| Ammonium Thiosulfate | 8 | g/l |
| Sulfite/Thiosulfate ratio | 5.25 | |
| Hydrazine hydrate | 15 | ml/l |
| 3,5-dihydroxybenzoic acid | 25 | g/l |
| pH | 7.0 | |
| Temperature | 70° | C. |

Gold deposits were produced from the above solution and operating conditions by electroless plating onto immersion Au plated on an underlying electroless nickel deposit. The thickness obtained was 38.2 microinches after 1 hour. The gold deposits had a uniform and yellow appearance. The bath showed no plate out or other instability.

### Example 2

An electroless gold plating solution was prepared and carried out by combining the following:

| Gold as Ammonium Gold Sulfite | 3.4 | g/l |
|---|---|---|
| Ammonium Sulfite | 35 | g/l |
| Ammonium Thiosulfate | 8 | g/l |
| Sulfite/Thiosulfate ratio | 4.375 | |
| Hydrazine hydrate | 12 | ml/l |
| pH | 7.1 | |
| Temperature | 70° | C. |

Gold deposits were produced from the above solution and operating conditions by electroless plating onto immersion Au plated on an underlying electroless nickel deposit. The thickness obtained was 74.9 microinches after 1 hour. The gold deposits had uneven and yellow appearance. The bath showed Au coating on the wall and the solution changed to a brown color.

### Example 3

An electroless gold plating solution was prepared and carried out by combining the following:

| Gold as Ammonium Gold Sulfite | 3.4 | g/l |
|---|---|---|
| Ammonium Sulfite | 45 | g/l |
| Ammonium Thiosulfate | 8 | g/l |
| Sulfite/Thiosulfate ratio | 5.625 | |
| Thiourea | 15 | g/l |
| 2,4-dihydroxybenzoic acid | 25 | g/l |
| pH | 6.8 | |
| Temperature | 70° | C. |

Gold deposits were produced from the above solution and operating conditions by electroless plating onto immersion Au plated on an underlying electroless nickel deposit. The thickness obtained was 23.1 microinches after 1 hour. The gold deposits had a uniform and yellow appearance. The bath showed no plate out or other instability.

### Example 4

An electroless gold plating solution was prepared and carried out by combining the following:

| Gold as Ammonium Gold Sulfite | 3.4 | g/l |
|---|---|---|
| Ammonium Sulfite | 45 | g/l |
| Ammonium Thiosulfate | 8 | g/l |
| Sulfite/Thiosulfate ratio | 5.625 | |
| pyrogallol | 18 | g/l |
| 3,5-dihydroxybenzoic acid | 20 | g/l |
| pH | 6.8 | |
| Temperature | 70° | C. |

Gold deposits were produced from the above solution and operating conditions by electroless plating onto immersion Au plated on an underlying electroless nickel deposit. The thickness obtained was 42.7 microinches after 1 hour. The gold deposits had a uniform and yellow appearance. The bath showed no plate out or other instability.

### Example 5

An electroless gold plating solution was prepared and carried out by combining the following:

| Gold as Ammonium Gold Sulfite | 3.4 | g/l |
|---|---|---|
| Ammonium Sulfite | 45 | g/l |
| Ammonium Thiosulfate | 8 | g/l |
| Sulfite/Thiosulfate ratio | 5.625 | |
| Hydrazine hydrate | 15 | ml/l |
| 2,4-dihydroxybenzoic acid | 25 | g/l |
| pH | 7.2 | |
| Temperature | 70° | C. |

Gold deposits were produced from the above solution and operating conditions by electroless plating onto immersion Au plated on an underlying electroless nickel deposit. The thickness obtained was 43.1 microinches after 1 hour. The gold deposits had a uniform and yellow appearance. The bath showed no plate out or other instability.

### Example 6

An electroless gold plating solution was prepared and carried out by combining the following:

| Gold as Ammonium Gold Sulfite | 3.4 | g/l |
|---|---|---|
| Ammonium Sulfite | 45 | g/l |
| Ammonium Thiosulfate | 8 | g/l |
| Sulfite/Thiosulfate ratio | 5.625 | |
| Pyrogallol | 18 | g/l |
| 3,5-dihydroxybenzoic acid | 20 | g/l |
| Ammonium tartrate | 23 | g/l |
| pH | 6.8 | |
| Temperature | 70° | C. |

Gold deposits were produced from the above solution and operating conditions by electroless plating onto immersion Au plated on an underlying electroless nickel deposit. The thickness obtained was 47.2 microinches after 1 hour. The gold deposits had a uniform and yellow appearance. The bath showed no plate out or other instability.

### Example 7

An electroless gold plating solution was prepared and carried out by combining the following:

| Gold as Ammonium Gold Sulfite | 3.4 | g/l |
|---|---|---|
| Ammonium Sulfite | 40 | g/l |
| Ammonium Thiosulfate | 8 | g/l |
| Sulfite/Thiosulfate ratio | 5 | |
| Pyrogallol | 18 | g/l |
| Ammonium tartrate | 23 | g/l |
| pH | 7.0 | |
| Temperature | 70° | C. |

Gold deposits were produced from the above solution and operating conditions by electroless plating onto immersion Au plated on an underlying electroless nickel deposit. The thickness obtained was 58.5 microinches after 1 hour. The gold deposits had a uniform and yellow appearance. The bath showed lots of precipitate and changed to a brown color.

### Example 8

An electroless gold plating solution was prepared and carried out by combining the following:

| Gold as Ammonium Gold Sulfite | 3.4 | g/l |
|---|---|---|
| Ammonium Sulfite | 40 | g/l |
| Ammonium Thiosulfate | 8 | g/l |
| Sulfite/Thiosulfate ratio | 5 | |
| Hydrazine hydrate | 15 | ml/l |
| 3,5-dihydroxybenzoic acid | 25 | g/l |
| Ammonium tartrate | 23 | g/l |
| pH | 6.8 | |
| Temperature | 70° | C. |

Gold deposits were produced from the above solution and operating conditions by electroless plating onto immersion Au plated on an underlying electroless nickel deposit. The thickness obtained was 41.6 microinches after 1 hour. The gold deposits had a uniform and yellow appearance. The bath showed no plate out or other instability.

### Example 9

An electroless gold plating solution was prepared and carried out by combining the following:

| Gold as Ammonium Gold Sulfite | 3.4 | g/l |
|---|---|---|
| Ammonium Sulfite | 40 | g/l |
| Ammonium Thiosulfate | 8 | g/l |
| Sulfite/Thiosulfate ratio | 5 | |
| Hydrazine hydrate | 15 | ml/l |
| 3,5-dihydroxybenzoic acid | 35 | g/l |
| Ammonium tartrate | 23 | g/l |
| pH | 6.4 | |
| Temperature | 70° | C. |

Gold deposits were produced from the above solution and operating conditions by electroless plating onto immersion Au plated on an underlying electroless nickel deposit. The thickness obtained was 21.7 microinches after 1 hour. The gold deposits had a uniform and yellow appearance. The bath showed no plate out or other instability.

### Example 10

An electroless gold plating solution was prepared and carried out by combining the following:

| Gold as Ammonium Gold Sulfite | 3.4 | g/l |
|---|---|---|
| Ammonium Sulfite | 45 | g/l |
| Ammonium Thiosulfate | 8 | g/l |
| Sulfite/Thiosulfate ratio | 5.625 | |
| Pyrogallol | 18 | g/l |
| 2,4-dihydroxybenzoic acid | 20 | g/l |
| Ammonium tartrate | 23 | g/l |
| pH | 6.8 | |
| Temperature | 70° | C. |

Gold deposits were produced from the above solution and operating conditions by electroless plating onto immersion Au plated on an underlying electroless nickel deposit. The thickness obtained was 55.8 microinches after 1 hour. The gold deposits had a uniform and yellow appearance. The bath showed no plate out or other instability.

### Example 11

An electroless gold plating solution was prepared and carried out by combining the following:

| Gold as sodium Gold Sulfite | 3.4 | g/l |
|---|---|---|
| Sodium Sulfite | 54 | g/l |
| Sodium Thiosulfate pentahydrate | 14 | g/l |
| Sulfite/Thiosulfate ratio | 3.85 | |
| Pyrogallol | 18 | g/l |
| 3,5-dihydroxybenzoic acid | 22 | g/l |
| Tartaric Acid | 20 | g/l |
| pH | 6.9 | |
| Temperature | 70° | C. |

Gold deposits were produced from the above solution and operating conditions by electroless plating onto immersion Au plated on an underlying electroless nickel deposit an article. The thickness obtained was 23.5 microinches after 1 hour. The gold deposits had a uniform, but dark orange deposit. The bath showed no plate or and other instability.

### Example 12

An electroless gold plating solution was prepared and carried out by combining the following:

| Gold as sodium Gold Sulfite | 3.4 | g/l |
|---|---|---|
| Sodium Sulfite | 54 | g/l |
| Sodium Thiosulfate pentahydrate | 14 | g/l |
| Sulfite/Thiosulfate ratio | 3.85 | |
| Pyrogallol | 18 | g/l |
| 3,5-dihydroxybenzoic acid | 22 | g/l |
| Tartaric Acid | 20 | g/l |
| Ethylenediamine | 2 | g/l |
| pH | 6.9 | |
| Temperature | 70° | C. |

Gold deposits were produced from the above solution and operating conditions by electroless plating onto immersion Au plated on an underlying electroless nickel deposit. The thickness obtained was 54.6 microinches after 1 hour. The gold deposits had a uniform and yellow appearance. The bath showed no plate out or other instability.

### Example 13

An electroless gold plating solution was prepared and carried out by combining the following:

| Gold as sodium Gold Sulfite | 3.4 | g/l |
|---|---|---|
| Sodium Sulfite | 45 | g/l |
| Sodium Thiosulfate pentahydrate | 23 | g/l |
| Sulfite/Thiosulfate ratio | 1.96 | |
| Pyrogallol | 54 | g/l |
| 3,5-dihydroxybenzoic acid | 22 | g/l |
| Ammonium Tartarate | 23 | g/l |
| Ethylenediamine | 0.5 | g/l |
| Ammonium biborax | 2 | g/l |
| pH | 6.5 | |
| Temperature | 65° | C. |

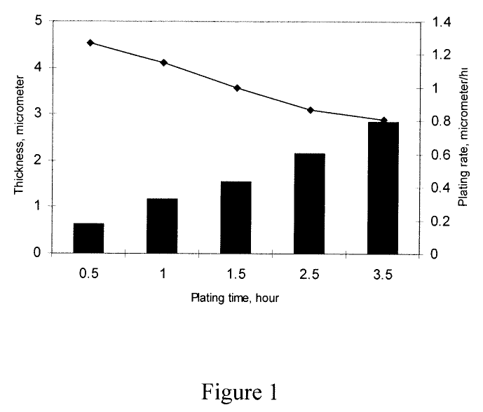

Gold deposits were produced from the above solution and operating conditions by electroless plating onto immersion Au plated on an underlying electroless nickel deposit. The gold deposit with plating time as shown in FIG. 1 was built up to 3 μm for 3.5 hours and the plating rate was decreased with increasing plating time. The gold deposits had a uniform and yellow appearance. The bath showed no plate out or other instability.

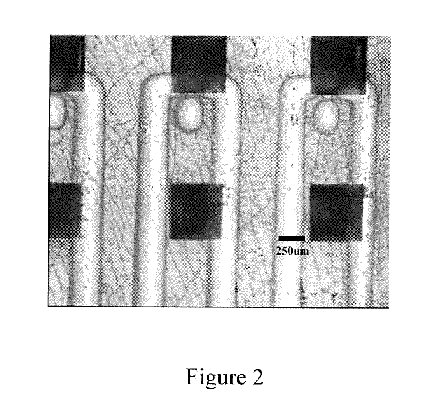

The electroless gold deposit shown in the FIG. 2 was plated on a sputtered gold underlayer that has pre-defined gold lines (250 μm line width) on the polymer substrate for 10 minutes. The electroless gold deposit was selectively plated on pre-defined gold lines without any extraneous plating on the polymer substrate. The result was electroless gold plating on pre-defined gold lines on the polymer substrate.

The present disclosure uses gold as an example of a preferred metal to be electrolessly deposited, but the teachings of this invention are also applicable to other metals, such as silver or palladium, for example. The skilled artisan will realize that the solution may need minor modifications to find the optimum solution-soluble compounds of those metals but the other bath additives should be essentially the same as those disclosed herein.

What is claimed is:

1. An electroless gold plating solution comprising a solution-soluble gold compound that provides gold ions, a complexing agent for the gold ions comprising a mixture of a sulfite compound and a thiosulfate compound in a weight ratio of greater than 1:2 to 50:1, a reducing agent, and a benzoic acid compound having one to four hydroxyl group(s) or a solution-soluble salt thereof in an amount sufficient to act as a stabilizer for the solution.

2. The electroless gold solution of claim 1, wherein the solution-soluble gold compound is a sulfite gold salt or a thiosulfate gold salt and the complexing agent is present in a weight ratio of greater than 1:1 to 25:1.

3. The electroless gold solution of claim 2, wherein the solution-soluble gold compound is present in an amount of about 1 to 20 g/l.

4. The electroless gold solution of claim 1, the complexing agent is present in an amount of about 5 to 125 g/l.

5. The electroless gold solution of claim 4, wherein the mixture of sulfite and thiosulfate compounds includes those having alkali metal, ammonium or alkyl cations.

6. The electroless gold solution of claim 1, wherein reducing agent is one or more of hypophosporous acid, hydroxylamine, hydrazine, hydroquinone, catechol, pyrogallol, gallic acid, thiourea, urea, ammonium hydroxyl sulfonic acid, or one of their solution-soluble salts.

7. The electroless gold solution of claim 6, wherein the reducing agent is present in an amount of about 1 to 60 g/l.

8. The electroless gold solution of claim 1, wherein the benzoic acid compound is present in an amount of about 5 to 50 g/l.

9. The electroless gold solution of claim 8, wherein the benzoic acid compound is a dihydroxy or trihydroxy benzoic acid and has two or three hydroxyl groups.

10. The electroless gold solution of claim 9, wherein the benzoic acid compound is 2,4-dihydroxybenzoic acid, 2,5-dihydroxybenzoic acid, 3,4-dihydroxybenzoic acid, 3,5-dihydroxybenzoic acid, 2,3-dihydroxybenzoic acid, or 2,6-dihydroxybenzoic acid, or is a dihydroxy benzoate of an alkali metal or a halide.

11. The electroless gold solution of claim 1, which further contains a tartaric acid or one of its solution-soluble salts as a grain refiner.

12. The electroless gold solution of claim 11, wherein the grain refiner is present in an amount of about 1 to 40 g/l.

13. The electroless gold solution of claim 1, which further comprises a pH regulating compound that does not have alkali metal ions and the pH is maintained in the range of about 5 to 9.

14. The electroless gold solution of claim 13 wherein the pH regulating compounds is ammonium borate, triethanolamine, or ammonium phosphate and the pH is maintained in the range of about 5.5 to 7.5.

15. The electroless gold plating solution of claim 13, which is free of alkali metal ions.

16. The electroless gold plating solution of claim 1, which further comprises one or more of a polyamine and polyaminepolycarboxylic acid or one of their solution-soluble salts as a surfactant.

17. A method for electroless gold plating which comprises contacting a substrate to be plated with the electroless plating solution of claim 1 for a time sufficient to provide an electroless gold deposit upon the portions of the substrate that are contacted by the solution.

18. The method of claim 17, wherein the substrate is immersed in the solution and its entire outer surface is provided with an electroless gold deposit.

19. The method of claim 17, which further comprises providing a substrate protecting organic material so that the gold plating is provided on selected portions of the substrate.

20. The method of claim 19, wherein the substrate protecting organic material is a benzotriazole, mercaptobezimidazole, or imidazole compound.
